(19) United States
(12) Patent Application Publication
(10) Pub. No.: US 2026/0221790 A1
(43) Pub. Date: Jul. 30, 2026

(54) BATTERY SYSTEM AND METHOD OF OPERATING BATTERY SYSTEM

(71) Applicant: Caterpillar Inc., Peoria, IL (US)

(72) Inventors: Alexander Charles Brown, Spalding (GB); Stephen Edwards, Peterborough (GB)

(73) Assignee: Caterpillar Inc., Peoria, IL (US)

(21) Appl. No.: 19/040,991

(22) Filed: Jan. 30, 2025

(51) Int. Cl. H02J 7/00

(52) U.S. Cl. CPC H02J 7/56; H02J 7/80; H02J 7/94; H02J 7/96

(57) ABSTRACT

A battery system includes at least two battery strings, and a controller including one or more processors communicably coupled with each of one or more memories and the at least two battery strings. The one or more processors are configured to determine an operating parameter associated with each of the at least two battery strings, compare the operating parameter of the at least two battery strings with each other, determine a battery string, from the at least two battery strings, that has a lowest value of the operating parameter, establish a connection between the load and the battery system via the battery string, from the at least two battery strings, that has the lowest value of the operating parameter. The operating parameter includes at least one of a current across each of the at least two battery strings and a voltage across each of the at least two battery strings.

### TECHNICAL FIELD

The present disclosure relates to a battery system and a method of operating the battery system.

### BACKGROUND

A battery system is used in a variety of applications as a means of power supply. For example, the battery system is being increasingly implemented in passenger vehicles, construction machines, and the like, to provide power supply.

Typically, a high voltage battery system includes one or more battery strings. Each battery string may include any number of battery modules that store chemical energy and release electrical energy as a power source. The battery system also includes one or more contactors connected with the corresponding battery string. The contactors may be used to establish and/or break a connection i.e., an electric circuit between a load and the battery system. In an example, the contactors may be used to establish or break the electric circuit, thereby allowing a corresponding battery string of the battery system to be charged, discharged, or isolated.

The contactors will experience wear over a lifetime of the battery system and therefore need to be replaced. For example, a contactor needs to be replaced if the contactor is worn beyond a limit, otherwise the worn contactor may cause damage to the battery system and may also affect an operation of the battery system. During an operation of the battery system, the contactors open or close under different conditions, thereby experiencing different make/break current flows, which leads to wear of the contactors at different rates. Further, different specifications of the contactors may also lead to wear of the contactors at the different rates. It may be desirable to replace multiple contactors at the same time to reduce maintenance efforts. However, as the contactors wear at different rates, in some cases, only one contactor may have to be replaced at a time which may increase a number of maintenance events and efforts.

U.S. Patent Application 2023/097052 describes a method for operating a switching arrangement of a rechargeable energy storage system, RESS. The RESS includes parallelly arranged battery packs and the switching arrangement comprising an associated contactor for each battery pack. The contactors are configured to connect and disconnect the battery packs relative a traction voltage bus by closing and opening, respectively, the traction voltage bus being connected to at least one load. The method includes providing a window of opportunity in which no request for powering the load by the battery packs, and no request for charging the battery packs, are allowed to be implemented, in the window of opportunity, preventing the contactors to open enabling equalization due to current transfer between the battery packs, measuring the current transfer between the battery packs, and in response to the measured current transfer, preventing the contactors to open and/or opening the contactors.

### SUMMARY OF THE DISCLOSURE

In an aspect of the present disclosure, a battery system is provided. The battery system is connectable with a load. The battery system includes at least two battery strings. Each of the at least two battery strings includes a plurality of battery modules. The battery system also includes a controller including one or more memories and one or more processors communicably coupled with each of the one or more memories and the at least two battery strings. The one or more processors are configured to determine an operating parameter associated with each of the at least two battery strings. The operating parameter includes at least one of a current across each of the at least two battery strings and a voltage across each of the at least two battery strings. The one or more processors are also configured to compare the operating parameter of the at least two battery strings with each other. The one or more processors are further configured to determine a battery string, from the at least two battery strings, that has a lowest value of the operating parameter. The one or more processors are configured to establish a connection between the load and the battery system via the battery string, from the at least two battery strings, that has the lowest value of the operating parameter.

In another aspect of the present disclosure, a method of operating a battery system is provided. The battery system is connectable with a load. The battery system includes at least two battery strings. The method includes determining, by one or more processors of a controller, an operating parameter associated with each of the at least two battery strings. The one or more processors are communicably coupled with each of one or more memories of the controller and the at least two battery strings. The operating parameter includes at least one of a current across each of the at least two battery strings and a voltage across each of the at least two battery strings. The method also includes comparing, by the one or more processors, the operating parameter of the at least two battery strings with each other. The method further includes determining, by the one or more processors, a battery string, from the at least two battery strings, that has a lowest value of the operating parameter. The method includes establishing, by the one or more processors, a connection between the load and the battery system via the battery string, from the at least two battery strings, that has the lowest value of the operating parameter.

Other features and aspects of this disclosure will be apparent from the following description and the accompanying drawings.

### BRIEF DESCRIPTION OF THE DRAWINGS

FIG. 1 is a circuit diagram of an exemplary battery system, according to an example of the present disclosure;

FIG. 2 is a schematic block diagram of the battery system of FIG. 1, according to an example of the present disclosure; and

FIG. 3 is a flowchart for a method of operating the battery system of FIG. 1, according to an example of the present disclosure.

### DETAILED DESCRIPTION

Wherever possible, the same reference numbers will be used throughout the drawings to refer to the same or like parts.

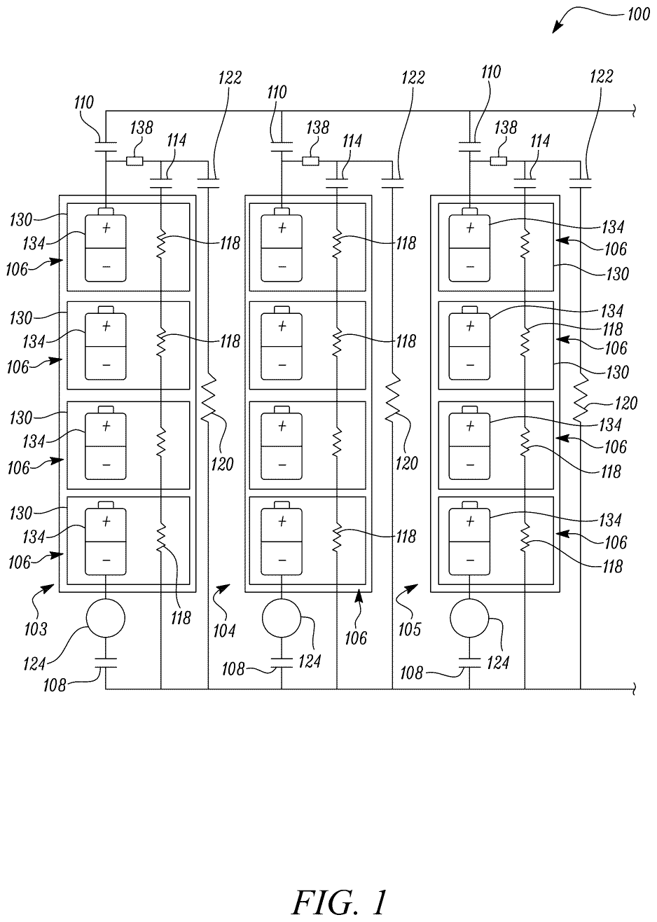

Referring to FIG. 1, a circuit diagram of an exemplary battery system 100 is illustrated. The battery system 100 may supply electrical power to a machine. The machine may include a moving machine or a stationary machine. In some examples, the machine may be a work/construction machine, for example.

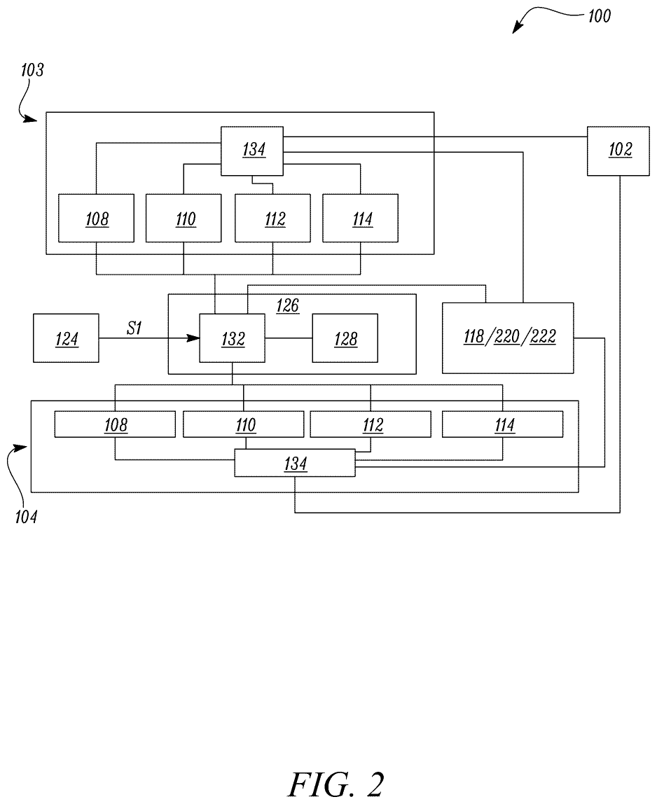

The battery system 100 is connectable with a load 102 (shown in FIG. 2). In some examples, the load 102 may be an alternating current (AC) load. In other examples, the load 102 may be a direct current (DC) load. In an example, the load 102 may be an electrical component associated with the machine.

The battery system 100 includes two or more battery strings 103, 104, 105. In the illustrated example of FIG. 1, the two or more battery strings 103, 104, 105 include a first battery string 103 and a second battery string 104. The two or more battery strings 103, 104, 105 further include a third battery string 105. It should be noted that the battery strings 103, 104, 105 are illustrated in the battery system 100 of FIG. 1 as an example. Alternatively, the battery system 100 may include any number of battery strings, based on application attributes. Each of the first, second, and third battery strings 103, 104, 105 are connected in parallel with each other. The first battery string 103, the second battery string 104, and the third battery string 105 are hereinafter interchangeably referred to as “the two or more battery strings 103, 104, 105”.

Each of the two or more battery strings 103, 104, 105 includes a number of battery modules 106. In the illustrated example of FIG. 1, each battery string 103, 104, 105 includes four battery modules 106. However, each battery string 103, 104, 105 may include any number of battery modules, as per application attributes. Each battery module 106 includes a housing 130. Each battery module 106 also includes a number of battery cells 134 disposed within the housing 130. The number of battery cells 134 may be electrically coupled to one another to provide a desired power output and voltage output to the load 102. A single battery cell 134 is illustrated in FIG. 1 as an example, however, each battery module 106 may include any number of battery cells 134 as per requirements.

The battery cells 134 may incorporate, for example, a lithium-ion battery technology to distribute the electrical power at a desired battery module voltage and a desired battery module amperage. It should be noted that the power distribution and power storage characteristics of the battery system 100 may be defined at least in part on the configurations of the battery cells 134 included in the battery system 100. In other examples, the battery system 100 may embody any other type of battery technology, such as a lead-acid battery technology, nickel metal hydride (NiMH) battery technology, and the like that converts chemical energy directly to electrical energy by utilizing a difference in bond energies of the compounds utilized in the construction of the battery module 106. Further, the battery cells 134 may include any capacity, voltage, energy, etc.

Each of the first battery string 103 and the second battery string 104 includes two or more contactors 108, 110, 112, 114. The two or more contactors 108, 110, 112, 114 may switch between an open state and a closed state to establish and/or break a connection associated with a circuit of the battery system 100.

The two or more contactors 108, 110, 112, 114 include a pair of main contactors 108, 110 connected to a corresponding battery string 103, 104, 105 from the two or more battery strings 103, 104, 105. Specifically, the pair of main contactors 108, 110 includes a main contactor 108 connected to a negative output of the two or more battery strings 103, 104, 105. In other words, each of the battery strings 103, 104, 105 includes the main contactor 108 connected to the negative output of the corresponding battery string 103, 104. The main contactor 108 is also known in the art as a negative contactor.

The pair of main contactors 108, 110 also includes a main contactor 110 connected to a positive output of the two or more battery strings 103, 104, 105. In other words, each of the battery strings 103, 104, 105 includes the main contactor 110 connected to the positive output of the corresponding battery string 103, 104. The main contactor 110 is also known in the art as a positive contactor.

The two or more contactors 108, 110, 112, 114 also include a pre-charge contactor 112 (shown in FIG. 2) connected to the corresponding battery string 103, 104, 105 from the two or more battery strings 103, 104, 105. The two or more contactors 108, 110, 112, 114 further include a heating contactor 114 connected to the corresponding battery string 103, 104. Specifically, each of the first battery string 103, the second battery string 104, and the third battery string 105 includes a corresponding pre-charge contactor 112 and a corresponding heating contactor 114. The pre-charge contactor 112 may allow a current to flow in a corresponding battery string 103, 104, 105 in a controlled manner. Although a single pre-charge contactor 112 is shown herein, the battery system 100 may include multiple pre-charge contactors associated with the main contactors 108, 110 of the corresponding battery string 103, 104, 105, as per application requirements. Specifically, the battery system 100 may include one pre-charge contactor associated with the main contactor 108 and one pre-charge contactor associated with the main contactor 110.

The heating contactor 114 may be used to enable heating of the corresponding battery string 103, 104, 105 via a heater 118 associated with the corresponding battery module 106 of each battery string 103, 104, 105 of the battery system 100. The heater 118 may be switched on/off based on feedback from a battery thermal management system (not shown) of the battery system 100.

The battery system 100 further includes two or more sensors 124 corresponding to the two or more battery strings 103, 104, 105. Each of the two or more sensors 124 generates a first signal S1 (shown in FIG. 2) indicative of an operating parameter associated with a corresponding battery string 103, 104, 105 from the two or more battery strings 103, 104, 105. Each of the two or more sensors 124 includes a voltage sensor and/or a current sensor. In the illustrated example of FIG. 1, the sensor 124 includes a voltage sensor. The operating parameter includes a current across each of the two or more battery strings 103, 104, 105 and/or the voltage across each of the two or more battery strings 103, 104, 105.

Each of the battery strings 103, 104, 105 of the battery system 100 further includes a fuse 138 connected with the main contactor 110 and the heating contactor 114 of the corresponding battery string 103, 104, 105. The fuse 138 may provide an overcurrent protection to the corresponding battery string 103, 104, 105.

The battery system 100 further includes a preloading device 118, 120, 122 connectable with one or more each of the two or more battery strings 103, 104, 105. The preloading device 118, 120, 122 includes the heater 118, a balancing resistor 120, a variable resistor, and/or a dedicated load generating resistor 122. The balancing resistor 120 may ensure uniform voltage across each of the two or more battery strings 103, 104, 105. The dedicated load generating resistor 122 may allow dissipation of excess current and/or voltage in the two or more battery strings 103, 104, 105. The variable resistor may modify the voltage across the battery string 103, 104, 105. In an example, the variable resistor may include a rheostat. It should be noted that the present disclosure is not limited to a type of the preloading device 118, 120, 122, and the preloading device 118, 120, 122 may include any other electrical component.

Referring to FIG. 2, a schematic block diagram of the battery system 100 of FIG. 1 is illustrated, according to an example of the present disclosure. The first battery string 103 and the second battery string 104 are illustrated in FIG. 2 as an example. However, details provided herein are equally applicable to all the battery strings 103, 104, 105 (see FIG. 1). The battery system 100 further includes a controller 126. The controller 126 includes one or more memories 128 and one or more processors 132 communicably coupled with each of the one or more memories 128, and the two or more battery strings 103, 104, 105. Further, the one or more processors 132 are communicably coupled with the two or more sensors 124.

The one or more memories 128 may include any means of storing information, including a hard disk, an optical disk, a floppy disk, read only memory (ROM), random access memory (RAM), programmable ROM (PROM), electrically erasable PROM (EEPROM), or other computer-readable memory media.

It should be noted that the one or more processors 132 may embody a single microprocessor or multiple microprocessors for receiving various input signals and generating output signals. Numerous commercially available microprocessors may perform the functions of the processors 132. The one or more processors 132 may further include a general processor, a central processing unit, an application specific integrated circuit (ASIC), a digital signal processor, a field programmable gate array (FPGA), a digital circuit, an analog circuit, a microcontroller, any other type of processor, or any combination thereof. The one or more processors 132 may include one or more components that may be operable to execute computer executable instructions or computer code that may be stored and retrieved from the one or more memories 128.

The one or more processors 132 determine the operating parameter associated with each of the two or more battery strings 103, 104. The operating parameter includes the current across each of the two or more battery strings 103, 104 and/or the voltage across each of the two or more battery strings 103, 104. Specifically, the one or more processors 132 receive, from each of the two or more sensors 124, the first signal S1 indicative of the operating parameter associated with the two or more battery strings 103, 104 to determine the operating parameter associated with each of the two or more battery strings 103, 104. In the illustrated example of FIG. 2, the operating parameter includes the voltage across each of the two or more battery strings 103, 104.

The one or more processors 132 compare the operating parameter of the two or more battery strings 103, 104 with each other. Specifically, the processors 132 compare the voltage across each of the two or more battery strings 103, 104 with each other.

The one or more processors 132 determine a battery string 103, 104, from the two or more battery strings 103, 104, that has a lowest value of the operating parameter. Specifically, the processors 132 determine which of the first battery string 103 and the second battery string 104 has the lower voltage value.

The one or more processors 132 establish the connection between the load 102 and the battery system 100 via the battery string 103, 104, from the two or more battery strings 103, 104, that has the lowest value of the operating parameter. Specifically, the one or more processors 132 establish the connection between the load 102 and the battery system 100 via the pre-charge contactor 112 of the battery string 103, 104 that has the lowest value of the operating parameter. For example, if the first battery string 103 has the lowest value of the voltage than the second battery string 104, the one or more processors 132 establish the connection between the load 102 and the battery system 100 via the pre-charge contactor 112 of the first battery string 103.

Further, the one or more processors 132 establish a connection between the preloading device 118, 120, 122 and the battery string 103, 104, from the two or more battery strings 103, 104, that has a highest value of the operating parameter, so that the operating parameter of the corresponding battery string 103, 104 is at least equal to the lowest value of the operating parameter. In some examples, the preloading device 118, 120, 122 can be any one of the heater 118, the balancing resistor 120, the variable resistor, and the dedicated load generating resistor 122. In other examples, the preloading may be done using one or more of the heater 118, the balancing resistor 120, the variable resistor, and the dedicated load generating resistor 122. For example, if the second battery string 104 has the highest value of the operating parameter, the one or more processors 132 establish the connection between the preloading device 118, 120, 122 and the second battery string 104, so that the operating parameter of the second battery string 104 is at least equal to the lowest value of the operating parameter of the first battery string 103. Specifically, the preloading device 118, 120, 122 and the second battery string 104 are connected to lower the voltage across the second battery string 104.

Furthermore, the one or more processors 132 establish the connection between the load 102 and the battery system 100 via the battery string 103, 104 that is connected with the preloading device 118, 120, 122, after the operating parameter of the corresponding battery string 103, 104 is at least equal to the lowest value of the operating parameter. The one or more processors 132 disconnect the preloading device 118, 120, 122 and the battery string 103, 104 after establishing the connection between the load 102 and the battery system 100 via the battery string 103, 104 that is connected with the preloading device 118, 120, 122. For example, the one or more processors 132 establish the connection between the load 102 and the battery system 100 via the second battery string 104 that is connected with the preloading device 118, 120, 122, after the operating parameter of the second battery string 104 is at least equal to the lowest value of the operating parameter of the first battery string 103. The one or more processors 132 then disconnect the preloading device 118, 120, 122 and the second battery string 104 after establishing the connection between the load 102 and the battery system 100 via the second battery string 104.

It should be noted that a comparison between the operating parameter of the battery strings 103, 104 is explained herein as an example, however, in actual implementation, the processors 132 will compare the operating parameter of each battery string 103, 104 105 (see FIG. 1) to determine the battery string 103, 104, 105 that should be used to establish and/or break the connection between the load 102 and the battery system 100.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is directed towards the battery system 100. The battery system 100 includes the two or more contactors 108, 110, 112, 114 associated with the two or more battery strings 103, 104, 105. The battery system 100 may optimize wear of each of the two or more contactors 108, 110, 112, 114 within the battery system 100

The battery system 100 includes the one or more processors 132 that operated to minimize the wear across the two or more contactors 108, 110, 112, 114 by establishing the connection between the load 102 and the battery system 100 via the battery string 103, 104, 105 that has the lowest value of the operating parameter. Further, the one or more processors 132 establish the connection between the preloading device 118, 120, 122 and the battery string 103, 104, 105 that has the highest value of the operating parameter so that the value of the operating parameter is reduced. In other words, if the processors 132 determine the battery string 103, 104, 105 with higher voltage value, the one or more processors 132 may suppress the voltage of the battery string 103, 104, 105 using the preloading device 118, 120, 122. Further, the preloading device 118, 120, 122 may balance the voltage across the battery system 100. Furthermore, the technique of preloading the battery strings 103, 104, 105 may also be used for reassembling of the battery modules 106 and/or the battery strings 103, 104, 105 within the battery system 100.

The preloading device 118, 120, 122 may modify a current output of each of the battery strings 103, 104, 105 without modifying the voltage of any of the battery strings 103, 104, 105, so as to balance the current output of each battery string 103, 104, 105 across the battery system 100. This may help in modifying a resistance of each battery string 103, 104, 105 to correct an effect of weak battery cells 134 in the corresponding battery string 103, 104, 105, thereby providing an even state of charge (SOC) drop across the battery strings 103, 104, 105 of the battery system 100.

Therefore, the battery system 100 may reduce a state of wear of two or more contactors 108, 110, 112, 114 by reducing a difference in the voltages across the two or more battery strings 103, 104, 105. Further, the battery system 100 may increase a service life of the contactors 108, 110, 112, 114, before a need to replace the contactors 108, 110, 112, 114 without causing failure. Further, the battery system 100 may even out the wear across the two or more contactors 108, 110, 112, 114 and the two or more contactors 108, 110, 112, 114 may have a similar state of wear.

Further, the battery system 100 may allow service and/or replacement of the contactors 108, 110, 112, 114 at once, instead of service and/or replacement of one contactor at a time thereby, reducing cost associated with the service and/or replacement. Overall, the battery system 100 described herein is simple in construction and may be cost-effective. The present disclosure may also increase an interval time between repairs and/or replacement of the contactors 108, 110, 112, 114.

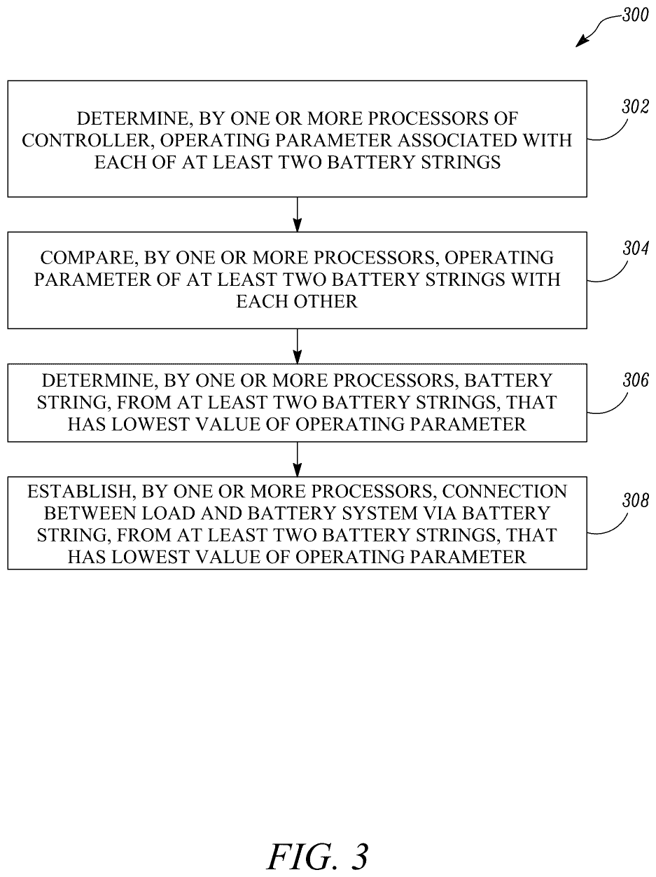

FIG. 3 is a flowchart for a method 300 of operating the battery system 100 of FIG. 1. The battery system 100 is connectable with the load 102. The battery system 100 includes the two or more battery strings 103, 104, 105. The two or more battery strings 103, 104, 105 include the first battery string 103 and the second battery string 104. Each of the first battery string 103 and the second battery string 104 includes the two or more contactors 108, 110, 112, 114. The two or more contactors 108, 110, 112, 114 include the pair of main contactors 108, 110 connected to the corresponding battery string 103, 104, 105 from the two or more battery strings 103, 104, 105. The two or more contactors 108, 110, 112, 114 also include the pre-charge contactor 112 connected to the corresponding battery string 103, 104, 105 from the two or more battery strings 103, 104, 105.

With reference to FIGS. 1 to 3, at step 302, the one or more processors 132 of the controller 126 determine the operating parameter associated with each of the two or more battery strings 103, 104, 105. The one or more processors 132 are communicably coupled with each of one or more memories 128 of the controller 126 and the two or more battery strings 103, 104, 105. The operating parameter includes the current across each of the two or more battery strings 103, 104, 105 and/or the voltage across each of the two or more battery strings 103, 104, 105.

At step 304, the one or more processors 132 compare the operating parameter of the two or more battery strings 103, 104, 105 with each other.

At step 306, the one or more processors 132 determine the battery string 103, 104, 105, from the two or more battery strings 103, 104, 105, that has the lowest value of the operating parameter.

At step 308, the one or more processors 132 establish the connection between the load 102 and the battery system 100 via the battery string 103, 104, from the two or more battery strings 103, 104, 105 that has the lowest value of the operating parameter. The step 308 further includes connecting, by the one or more processors 132, the load 102 and the battery system 100 via the pre-charge contactor 112 of the battery string 103, 104, 105 that has the lowest value of the operating parameter.

The method 300 further includes a step (not shown) at which two or more sensors 124 corresponding to the two or more battery strings 103, 104, 105 generate the first signal S1 indicative of the operating parameter associated with the corresponding battery string 103, 104, 105 from the two or more battery strings 103, 104, 105. The method 300 further includes a step (not shown) at which the one or more processors 132 receive the first signal S1 indicative of the operating parameter associated with the two or more battery strings 103, 104, 105 from each of the two or more sensors 124 to determine the operating parameter associated with each of the two or more battery strings 103, 104, 105. The two or more sensors 124 are communicably coupled with the one or more processors 132.

The method 300 includes a step (not shown) at which the one or more processors 132 establish the connection between the preloading device 118, 120, 122 associated with each of the two or more battery strings 103, 104, 105 and the battery string 103, 104, 105, from the two or more battery strings 103, 104, 105 that has the highest value of the operating parameter. The preloading device 118, 120, 122 is connectable with one or more of the two or more battery strings 103, 104, 105. The preloading device 118, 120, 122 includes the heater 118, the balancing resistor 120, the variable resistor, and/or the dedicated load generating resistor 122. The method 300 also includes a step (not shown) at which the value of the operating parameter of the battery string 103, 104, 105 that has the highest value of the operating parameter is reduced, so that the operating parameter of the corresponding battery string 103, 104, 105 is at least equal to the lowest value of the operating parameter, based on the connection between the preloading device 118, 120, 122 and the battery string 103, 104, 105.

The method 300 further includes a step (not shown) at which the one or more processors 132 establish the connection between the load 102 and the battery system 100 via the battery string 103, 104, 105 that is connected with the preloading device 118, 120, 122, after the operating parameter of the corresponding battery string 103, 104, 105 is at least equal to the lowest value of the operating parameter. The method 300 further includes a step (not shown) at which the one or more processors 132 disconnect the preloading device 118, 120, 122 and the battery string 103, 104, 105 after establishing the connection between the load 102 and the battery system 100 via the battery string 103, 104, 105 that is connected with the preloading device 118, 120, 122.

It should be noted that the steps 302, 304, 306, 308 of the method 300 may be performed in a sequence that is different from that explained in relation to FIG. 3. Further, various steps 302, 304, 306, 308 can be performed together.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A battery system, the battery system is connectable with a load, the battery system comprising:
at least two battery strings, wherein each of the at least two battery strings includes a plurality of battery modules; and
a controller including one or more memories and one or more processors communicably coupled with each of the one or more memories and the at least two battery strings, wherein the one or more processors are configured to:
determine an operating parameter associated with each of the at least two battery strings, wherein the operating parameter includes at least one of a current across each of the at least two battery strings and a voltage across each of the at least two battery strings;
compare the operating parameter of the at least two battery strings with each other;
determine a battery string, from the at least two battery strings, that has a lowest value of the operating parameter; and
establish a connection between the load and the battery system via the battery string, from the at least two battery strings, that has the lowest value of the operating parameter.

2. The battery system of claim 1, wherein the at least two battery strings include a first battery string and a second battery string.

3. The battery system of claim 2, wherein each of the first battery string and the second battery string includes at least two contactors.

4. The battery system of claim 3, wherein the at least two contactors include:
a pair of main contactors connected to a corresponding battery string from the at least two battery strings; and
a pre-charge contactor connected to the corresponding battery string from the at least two battery strings.

5. The battery system of claim 4, wherein the one or more processors are further configured to establish a connection between the load and the battery system via the pre-charge contactor of the battery string that has the lowest value of the operating parameter.

6. The battery system of claim 1 further comprising at least two sensors corresponding to the at least two battery strings, wherein each of the at least two sensors is configured to generate a first signal indicative of the operating parameter associated with a corresponding battery string from the at least two battery strings.

7. The battery system of claim 6, wherein the one or more processors are communicably coupled with the at least two sensors, and wherein the one or more processors are further configured to receive, from each of the at least two sensors, the first signal indicative of the operating parameter associated with the at least two battery strings to determine the operating parameter associated with each of the at least two battery strings.

8. The battery system of claim 6, wherein each of the at least two sensors includes at least one of a voltage sensor and a current sensor.

9. The battery system of claim 1 further comprising a preloading device connectable with each of the at least two battery strings, wherein the one or more processors are further configured to establish a connection between the preloading device and a battery string, from the at least two battery strings, that has a highest value of the operating parameter, so that the operating parameter of the corresponding battery string is at least equal to the lowest value of the operating parameter.

10. The battery system of claim 9, wherein the preloading device includes at least one of a heater, a balancing resistor, a variable resistor, and a dedicated load generating resistor.

11. The battery system of claim 9, wherein the one or more processors are further configured to:
establish a connection between the load and the battery system via the battery string that is connected with the preloading device, after the operating parameter of the corresponding battery string is at least equal to the lowest value of the operating parameter; and
disconnect the preloading device and the battery string after establishing the connection between the load and the battery system via the battery string that is connected with the preloading device.

12. A method of operating a battery system, the battery system is connectable with a load, the battery system includes at least two battery strings, the method comprising:
determining, by one or more processors of a controller, an operating parameter associated with each of the at least two battery strings, wherein the one or more processors are communicably coupled with each of one or more memories of the controller and the at least two battery strings, and wherein the operating parameter includes at least one of a current across each of the at least two battery strings and a voltage across each of the at least two battery strings;
comparing, by the one or more processors, the operating parameter of the at least two battery strings with each other;
determining, by the one or more processors, a battery string, from the at least two battery strings, that has a lowest value of the operating parameter; and
establishing, by the one or more processors, a connection between the load and the battery system via the battery string, from the at least two battery strings, that has the lowest value of the operating parameter.

13. The method of claim 12, wherein the at least two battery strings include a first battery string and a second battery string, and wherein each of the first battery string and the second battery string includes at least two contactors.

14. The method of claim 13, wherein the at least two contactors include:
a pair of main contactors connected to a corresponding battery string from the at least two battery strings; and
a pre-charge contactor connected to the corresponding battery string from the at least two battery strings.

15. The method of claim 14, wherein the step of establishing, by the one or more processors, the connection between the load and the battery system further includes connecting, by the one or more processors, the load and the battery system via the pre-charge contactor of the battery string that has the lowest value of the operating parameter.

16. The method of claim 12 further comprising generating, by at least two sensors corresponding to the at least two battery strings, a first signal indicative of the operating parameter associated with a corresponding battery string from the at least two battery strings.

17. The method of claim 16 further comprising receiving, by the one or more processors, the first signal indicative of the operating parameter associated with the at least two battery strings from each of the at least two sensors to determine the operating parameter associated with each of the at least two battery strings, wherein the at least two sensors are communicably coupled with the one or more processors.

18. The method of claim 12 further comprising:
establishing, by the one or more processors, a connection between a preloading device associated with each of the at least two battery strings and a battery string from the at least two battery strings that has a highest value of the operating parameter, wherein the preloading device is connectable with one or more of the at least two battery strings; and
reducing a value of the operating parameter of the battery string that has a highest value of the operating parameter, so that the operating parameter of the corresponding battery string is at least equal to the lowest value of the operating parameter, based on the connection between the preloading device and the battery string.

19. The method of claim 18, wherein the preloading device includes at least one of a heater, a balancing resistor, a variable resistor, and a dedicated load generating resistor.

20. The method of claim 18 further comprising:
establishing, by the one or more processors, a connection between the load and the battery system via the battery string that is connected with the preloading device, after the operating parameter of the corresponding battery string is at least equal to the lowest value of the operating parameter; and
disconnecting, by the one or more processors, the preloading device and the battery string after establishing the connection between the load and the battery system via the battery string that is connected with the preloading device.
